(19) United States
(12) Patent Application Publication
(10) Pub. No.: US 2011/0140329 A1
(43) Pub. Date: Jun. 16, 2011

(54) Modular Hydraulic Load Support Device

(76) Inventor: Winfred E. Mandody, Columbus, WI (US)

(21) Appl. No.: 12/968,821

(22) Filed: Dec. 15, 2010

Related U.S. Application Data
(60) Provisional application No. 61/286,876, filed on Dec. 16, 2009.

(51) Int. Cl. B25B 1/18

(52) U.S. Cl. 269/30

(57) ABSTRACT

A hydraulic load support device comprises a pump unit that includes a reservoir chamber configured to contain hydraulic fluid and a reservoir passageway in fluid communication with the reservoir chamber. The pump unit further includes a connection interface having a delivery passageway in fluid communication with the reservoir passageway. The pump unit further includes a handle connected to the reservoir chamber that is movable to drive hydraulic fluid from the reservoir chamber. The hydraulic load support device further includes a pivoted jaw frame affixed to the connection interface. The pivoted jaw frame is movable from a closed position to an open position and vice versa. The pivoted jaw frame includes a head passageway in fluid communication with the delivery passageway and an actuator including a fluid chamber in fluid communication with the head passageway to receive hydraulic fluid and thereby move the pivoted jaw frame to the open position.

### CROSS-REFERENCE TO RELATED APPLICATION

This application claims the benefit of U.S. Provisional Patent Application No. 61/286,876 filed Dec. 16, 2009, the disclosure of which is hereby incorporated by reference in its entirety.

### STATEMENT OF FEDERALLY SPONSORED RESEARCH OR DEVELOPMENT

Not applicable.

### BACKGROUND OF THE INVENTION

This invention relates to compact hydraulic load support devices, particularly manually operated hydraulic spreaders.

Compact hydraulic load support devices are well known for temporarily supporting heavy loads or applying large lifting forces. For example, automotive or “bottle” jacks are used to lift vehicles while performing maintenance. As another example, hydraulic spreaders are used to separate large structural platforms. Regardless of their specific purposes, hydraulic load support devices generally include a handle or lever that is repetitively actuated by an operator to pump hydraulic fluid from a reservoir. Hydraulic passageways direct the pressurized fluid to an actuator chamber to drive a piston and extend a connected rod. In some cases, the rod engages and thereby lifts an object. In other cases, the rod drives a link arm or jaw relative to other components to thereby lift an object or separate two objects.

Unfortunately, previous hydraulic load support devices were designed such that the components described above are structurally interconnected to a great extent. As such, failure of one component may require disassembly and down-time of other non-problematic components. In addition, structural interconnection also prevents previous hydraulic load support devices from being adapted for use in different load support situations in which specific device designs are most suitable.

Considering the drawbacks of previous designs, an improved hydraulic load support device is needed.

### SUMMARY OF THE INVENTION

In one aspect of the invention, a hydraulic load support device comprises a pump unit that includes a reservoir chamber configured to contain hydraulic fluid and a reservoir passageway in fluid communication with the reservoir chamber. The pump unit further includes a connection interface having a delivery passageway in fluid communication with the reservoir passageway. The pump unit further includes a handle connected to the reservoir chamber that is movable to drive hydraulic fluid from the reservoir chamber. The hydraulic load support device further includes a pivoted jaw frame affixed to the connection interface. The pivoted jaw frame is movable from a closed position to an open position and vice versa. The pivoted jaw frame includes a head passageway in fluid communication with the delivery passageway and an actuator including a fluid chamber in fluid communication with the head passageway to receive hydraulic fluid and thereby move the pivoted jaw frame to the open position.

In yet another aspect of the invention, a hydraulic load support device comprises a reservoir wall that defines a reservoir chamber configured to contain hydraulic fluid. A handle connects to the reservoir wall and is movable to thereby drive hydraulic fluid from the reservoir chamber. An adapter block detachably connects to the reservoir chamber and receives hydraulic fluid from the reservoir chamber. A head includes a first load supporting member and a second load supporting member movably connected to the first load supporting member. The head is connected to the adapter block and receives hydraulic fluid from the adapter block to thereby force the first load supporting member and the second load supporting member apart.

In yet another aspect of the invention, a hydraulic spreader comprises a reservoir wall that defines a reservoir chamber configured to contain hydraulic fluid. A manifold is disposed within the reservoir chamber, and the manifold includes an inlet passageway through which the hydraulic fluid in the reservoir chamber enters the manifold. The manifold also includes a plunger passageway in fluid communication with the inlet passageway and an outlet passageway in fluid communication with the plunger passageway. A plunger is disposed and movable within the plunger passageway, and a handle pivotally connects to the plunger. Movement of the handle relative to the reservoir wall causes the plunger to move in the plunger passageway and thereby draw the hydraulic fluid from the inlet passageway and force the hydraulic fluid to the outlet passageway. A connection interface is connected to the reservoir wall, and the connection interface includes a delivery passageway in fluid communication with the outlet passageway of the manifold. A first set of fasteners secure the reservoir wall to the connection interface, and a head assembly connects to the connection interface. The head assembly includes a lower jaw that has a head passageway in fluid communication with the delivery passageway. The lower jaw further includes an actuator chamber in fluid communication with the head passageway. A piston is disposed in the actuator chamber, and the piston is movable as the hydraulic fluid enters and exits the actuator chamber. A rod is supported by the piston, and an upper jaw pivotally connects to the lower jaw. The upper jaw is movable as the rod and piston move. A second set of fasteners secures the lower jaw to the connection interface.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

The invention will hereafter be described with reference to the accompanying drawings, wherein like reference numerals denote like elements, and:

FIG. 1 is a perspective view of an exemplary embodiment of a hydraulic load support device according to the invention;

FIG. 2 is another perspective view of the device of FIG. 1;

FIG. 3 is a side view of the device of FIG. 1 illustrating motion of a handle and an upper jaw;

FIG. 4 is a sectional view along line 4-4 of FIG. 1 illustrating the upper jaw in an open position;

FIG. 5 is a partial sectional view like FIG. 4, although illustrating the upper jaw in a closed position;

FIG. 6 is a sectional view along line 6-6 of FIG. 1 illustrating a pressure release pin; and

FIG. 7 is a hydraulic circuit schematic of the device of FIG. 1.

### DETAILED DESCRIPTION OF THE DRAWINGS

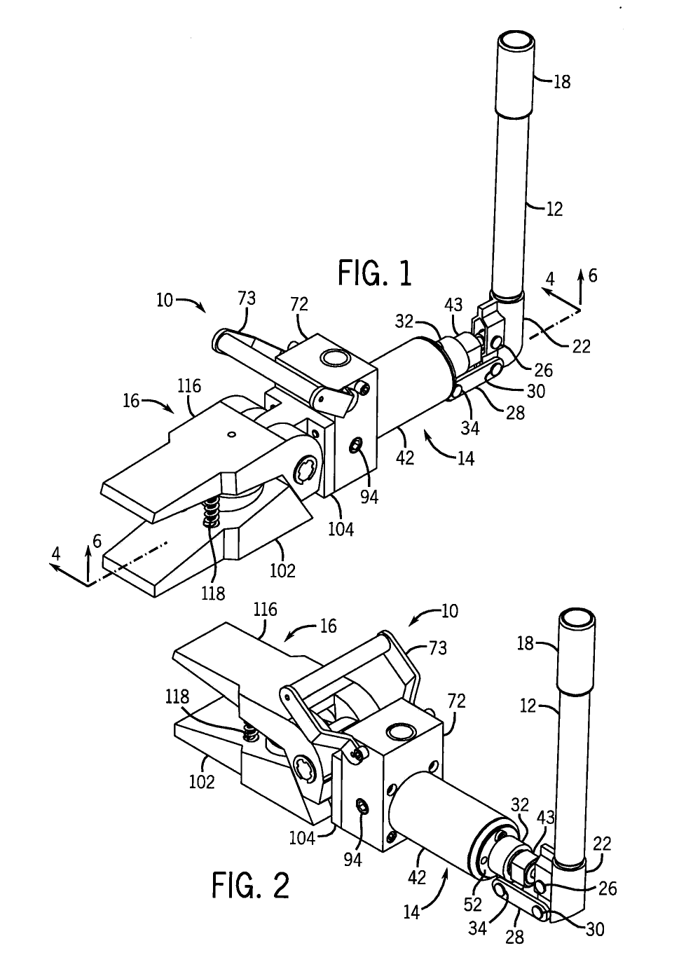

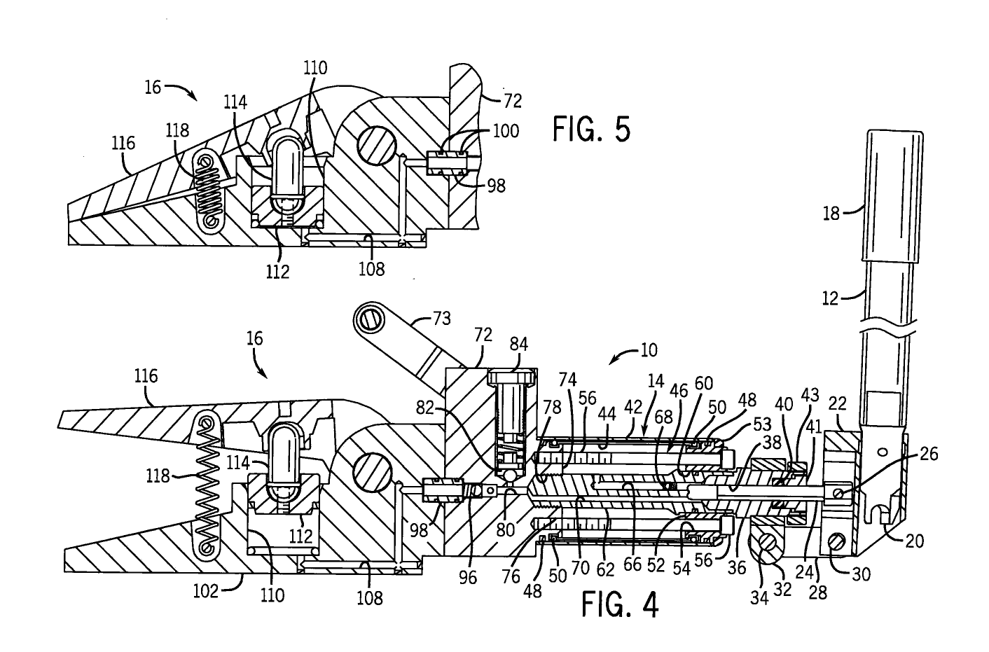

Referring now to the drawings and particularly FIGS. 1-7, an exemplary embodiment of a hydraulic load support device, such as a hydraulic spreader 10, according to the present invention includes a handle 12 that is movable to drive hydraulic fluid from a pump unit 14 to a pivoted jaw frame or head assembly 16. Delivery of hydraulic fluid to the head assembly 16 moves the spreader 10 from a closed position (FIG. 5) to an open position (FIG. 4). The aforementioned components provide a modular spreader 10 that may be easily assembled and repaired. As such, these components and their interactions are described in further detail in the following paragraphs, beginning with the handle 12 and concluding with the head assembly 16.

Referring now to FIGS. 1-4, the handle 12 is an elongated rod that includes a grip 18 at a distal end. A proximal end of the handle 12 detachably connects to a handle bracket 22 via a releasable pin (not shown), a threaded connection, or the like. The proximal end of the handle 12 also includes a tool tip 20 (FIG. 4) such that the handle 12 can be detached from the spreader 10 and the tool tip 20 can be used to release pressure from the head assembly 16. This aspect of the spreader 10 is described in further detail below.

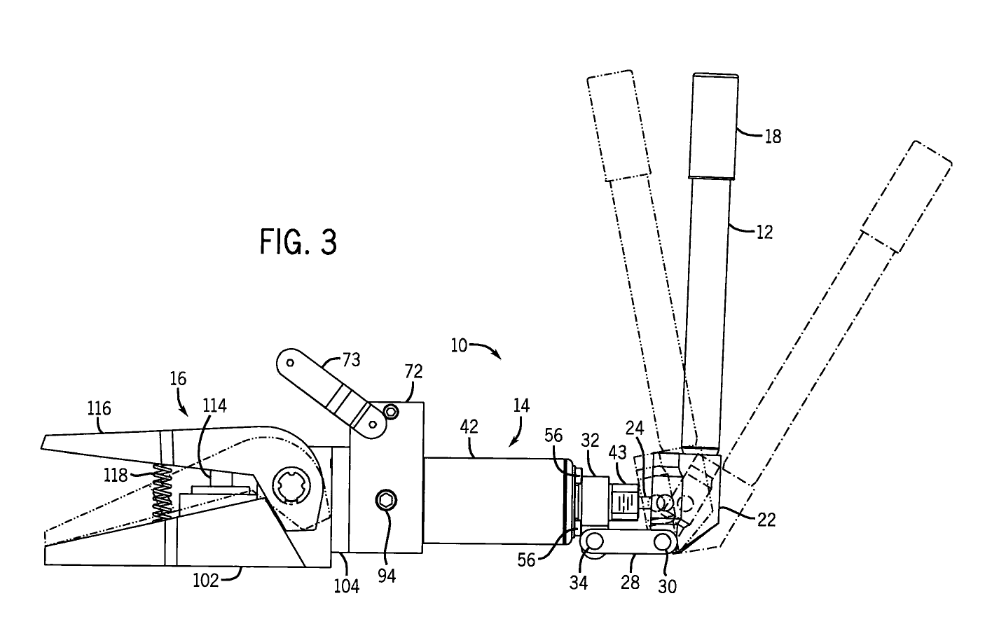

The handle bracket 22 pivotally connects to a translatable plunger 24 via a first pin 26 and an intermediate link 28 via a second pin 30. The intermediate link 28 pivotally connects to a ground link 32 via a third pin 34. As such, the handle 12 may be pivoted as shown in FIG. 3 to translate the plunger 24 and thereby drive hydraulic fluid from the pump unit 14 to the head assembly 16 as described in further detail below.

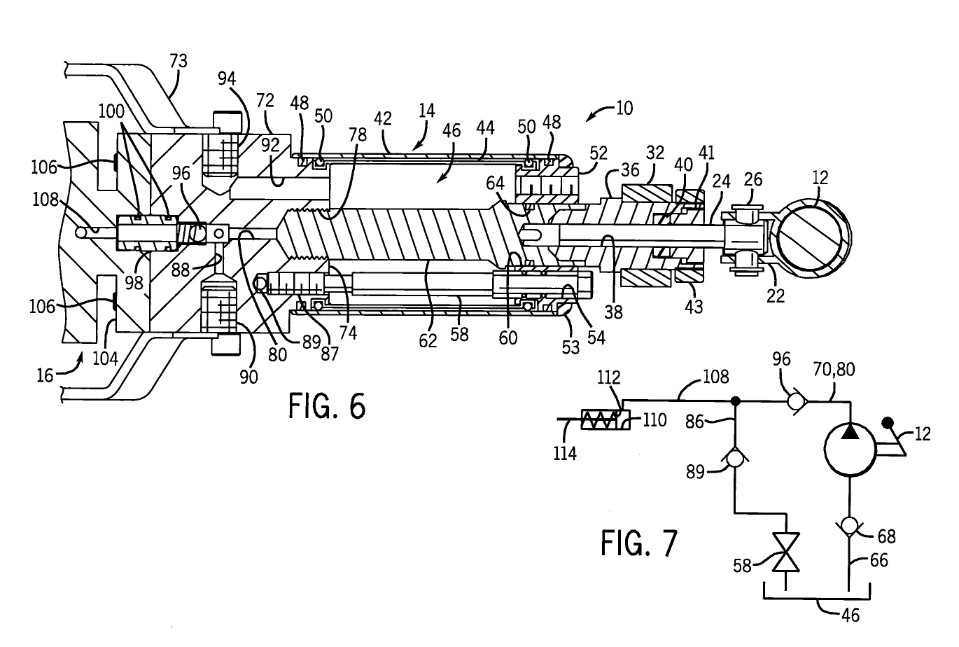

Referring specifically to FIGS. 4 and 6, the ground link 32 supports a plunger guide 36 that defines a plunger passageway 38 in which the plunger 24 moves as the handle 12 is pivoted. The plunger passageway 38 also accommodates a seal 40, such as an o-ring, to prevent hydraulic fluid leakage from the plunger guide 36. The seal 40 is held within the plunger passageway 38 by a removable nut 41. The plunger guide 36 also supports a lock nut 43 at its exposed end to hold the ground link 32 to the plunger guide 36.

The pump unit 14 further includes a hollow and generally cylindrical cistern 42. The cistern 42 houses a reservoir wall 44 that may be rubber or another similar material. In any case, the reservoir wall 44 defines a reservoir chamber 46 for holding hydraulic fluid that is delivered to the head assembly 16. The reservoir wall 44 and the cistern 42 support several seals 48, such as o-rings, and wire loops 50, such as spring steel wire loops, to prevent hydraulic fluid leakage from the reservoir chamber 46.

Still referring to FIGS. 4 and 6, distal ends of the cistern 42 and the reservoir wall 44 connect to a support bushing 52 that, in part, isolates the reservoir chamber 46 from the outside of the spreader. The support bushing 52 threadably engages a lock nut 53 that abuts the cistern 42 to secure the cistern 42 relative to the support bushing 52. However, the cistern 42 may alternatively include an inward shoulder (not shown) that engages support bushing 52 to secure the two components relative to one another.

The support bushing 52 includes outwardly disposed through holes 54 through which fasteners 56 and a release pin 58 extend as described in further detail below. The support bushing 52 also includes an inwardly disposed through hole 60 through which a manifold 62 extends.

The manifold 62 includes a distal end that detachably connects to the plunger guide 36. The distal end of the manifold 62 also partially defines the plunger passageway 38. Further still, the distal end of the manifold 62 supports a seal 64, such as an o-ring, to prevent hydraulic fluid leakage between the manifold 62 and the support bushing 52.

Adjacent the distal end, the manifold 62 includes an intermediate section that defines an inlet passageway 66. The inlet passageway 66 is in fluid communication with the reservoir chamber 46 and the plunger passageway 38. As such, the reservoir chamber 46 delivers hydraulic fluid to the plunger passageway 38 via the inlet passageway 66 as the plunger 24 moves away from the manifold 62. A check valve 68 disposed within the inlet passageway 66 prevents hydraulic fluid in the plunger passageway 38 from returning to the reservoir chamber 46 via the inlet passageway 66.

The intermediate section of the manifold 62 also defines an outlet passageway 70. The outlet passageway 70 is in fluid communication with the plunger passageway 38 and receives hydraulic fluid therefrom as the plunger 24 is driven towards the manifold 62. The outlet passageway 70 carries hydraulic fluid to a proximal end of the manifold 62 that detachably connects to an adapter block or connection interface 72.

As shown most clearly in FIGS. 1-3, the connection interface 72 mounts a carrying handle 73 and has a general block shape. However, a first side of the connection interface 72 includes an attachment projection 74 that supports the cistern 42 and the reservoir wall 44. The attachment projection 74 includes outwardly disposed blind holes 76 that threadably engage the fasteners 56. The attachment projection 74 also includes an inwardly disposed hole 78 that threadably engages the proximal end of the manifold 62.

The hole 78 is disposed adjacent a delivery passageway 80 in fluid communication with the outlet passageway 70 of the manifold 62. The delivery passageway 80 is in communication with a pressure relief passageway 82 that accommodates a pressure relief valve 84. The operating pressure of the pressure relief valve 84 may be adjusted by turning the valve 84 with a screwdriver, a hex key, or the like. The delivery passageway 80 is also in communication with a return passageway 86 (FIG. 7) in selective fluid communication with the reservoir chamber 46. A proximal end of the release pin 58 includes a retainer nut 87 that normally engages (e.g., threadably connects to) the wall of the return passageway 86 to prevent hydraulic fluid from passing from the return passageway 86 to the reservoir chamber 46. However, the release pin 58 may be disengaged from the return passageway 86 (preferably by rotating the head of the pin 58 using the tool tip 20 of the handle 12) to permit hydraulic fluid to return to the reservoir chamber 46. The return passageway 86 also preferably includes a check valve 89 to prevent hydraulic fluid from moving from the reservoir chamber 46 to the return passageway 86.

Referring specifically to FIG. 6, the delivery passageway 80 is also in fluid communication with a first filling passageway 88 that normally accommodates a first set screw 90 to prevent hydraulic fluid leakage from the connection interface 72. Of course, the set screw 90 may be temporarily removed to permit hydraulic fluid to be added to the spreader 10 or removed before conducting repairs. A second filling passageway 92 that normally accommodates a second set screw 94 is preferably in direct fluid communication with the reservoir chamber 46.

Referring again to FIGS. 4 and 6, the delivery passageway 80 also includes a check valve 96 to prevent hydraulic fluid from returning to the outlet passageway 70 of the manifold 62. Further still, the delivery passageway 80 also includes an enlarged section proximate a second side of the connection interface 72 that accommodates an interface capsule 98.

The interface capsule 98 extends from within the connection interface 72 into the head assembly 16, and as such, the interface capsule 98 permits easy alignment of the connection interface 72 and the head assembly 16 during manufacturing, after repairs, after interchanging head assemblies, or the like. The interface capsule 98 supports seals 100, such as o-rings, to prevent hydraulic fluid leakage between the pump unit 14 and the head assembly 16.

In addition to providing the aforementioned passageways, the connection interface 72 also spatially separates the cistern 42 and the reservoir wall 44 from the head assembly 16. As such, failure of one component may not require disassembly and/or replacement of other non-problematic components. Furthermore, the modular structure of the connection interface 72 also permits interchangeability of the head assembly 16 as described in further detail below.

Referring now to FIGS. 4 and 5, the pivoted jaw frame or head assembly 16 includes a first load supporting member or lower jaw 102 having a flange 104 that abuts the second side of the connection interface 72. The flange 104 has a three-dimensional generally rectangular shape and threadably engages fasteners 106 that extend through the connection interface 72 to secure the lower jaw 102. As such, the fasteners 106 may simply be removed to detach the head assembly 16 from the pump unit 14 thereafter permitting repairs or interchanging head assemblies.

The lower jaw 102 defines a head passageway 108 in fluid communication with the delivery passageway 80 of the connection interface 72. The lower jaw 102 also defines an actuator chamber 110 in fluid communication with the head passageway 108. A piston 112 is movably supported within the actuator chamber 110, and the piston 112 moves to the elevated position shown in FIG. 4 as the pump unit 14 delivers hydraulic fluid to the actuator chamber 110.

The piston 112 supports a rod 114 outside the actuator chamber 110. The rod 114 pushes a second load supporting member or an upper jaw 116 pivotally connected to the lower jaw 102 to the open position shown in FIG. 4 as the piston 112 moves to the elevated position. However, the upper jaw 116 and the lower jaw 102 are biased towards the closed position by extension springs 118. As such, the jaws 102 and 116 may be returned to the closed position of FIG. 5 by simply rotating the release pin 58 and thereby permitting hydraulic fluid to return to the reservoir chamber 46 as described above.

From the above description it should be apparent that the hydraulic load support device 10 is less structurally interconnected than previous designs. As such, failure of one component may not require disassembly and down-time of other non-problematic components. For example, a worn piston 112 does not require disassembly of the pump unit 14. Furthermore, the device 10 also permits interchangeability of pump units 14 and head assemblies 16 due to the modular structure of the connection interface 72. For example, any other head assembly having the same bolt pattern and head passageway location (to accommodate the interface capsule 98) can be connected to the pump unit 14. As another example, the pump unit 14 may be disconnected from the head assembly 16 and used in another application, such as supplying hydraulic fluid to a linear actuator. This interchangeability permits the device 10 to be used in different load support situations in which specific head sizes, shapes, and even other types of hydraulic components are most suitable.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A hydraulic load support device, comprising:
a pump unit including:
a reservoir chamber configured to contain hydraulic fluid;
a reservoir passageway in fluid communication with the reservoir chamber;
a connection interface having a delivery passageway in fluid communication with the reservoir passageway;
a handle connected to the reservoir chamber and being movable to drive hydraulic fluid from the reservoir chamber;
a pivoted jaw frame affixed to the connection interface, the pivoted jaw frame being movable from a closed position to an open position and vice versa and including:
a head passageway in fluid communication with the delivery passageway; and
an actuator including a fluid chamber in fluid communication with the head passageway to receive hydraulic fluid and thereby move the pivoted jaw frame to the open position.

2. The hydraulic load support device of claim 1, wherein the connection interface further includes a return passageway permitting the hydraulic fluid to exit the actuator and return to the reservoir chamber to thereby move the pivoted jaw frame to the closed position.

3. The hydraulic load support device of claim 1, wherein the pivoted jaw frame is detachably affixed to the connection interface.

4. The hydraulic load support device of claim 1, wherein the pivoted jaw frame is detachably affixed to the connection interface such that the pump unit is removable and operable to provide hydraulic fluid to another hydraulic device.

5. The hydraulic load support device of claim 1, further comprising an interface capsule disposed between the pivoted jaw frame and the connection interface and within the delivery passageway and the head passageway.

6. The hydraulic load support device of claim 1, wherein the pivoted jaw frame includes a lower jaw defining the head passageway and the fluid chamber of the actuator.

7. The hydraulic load support device of claim 1, wherein the pivoted jaw frame includes a lower jaw frame having a support flange abutting the connection interface.

8. The hydraulic load support device of claim 7, further comprising a set of fasteners detachably affixing the support flange to the connection interface.

9. A hydraulic load support device, comprising:
a reservoir wall defining a reservoir chamber configured to contain hydraulic fluid;
a handle connected to the reservoir wall and being movable to thereby drive hydraulic fluid from the reservoir chamber;
an adapter block detachably connected to the reservoir chamber and receiving hydraulic fluid from the reservoir chamber;
a head including a first load supporting member and a second load supporting member movably connected to the first load supporting member, the head being connected to the adapter block and receiving hydraulic fluid from the adapter block to thereby force the first load supporting member and the second load supporting member apart.

10. The hydraulic load support device of claim 9, further comprising:
a support bushing connected to the reservoir wall opposite the adapter block;
a set of fasteners extending through the support bushing and connected to the adapter block.

11. The hydraulic load support device of claim 9, wherein the head detachably connects to the adapter block.

12. The hydraulic load support device of claim 11, further comprising a set of fasteners extending through the adapter block and connected to the head.

13. The hydraulic load support device of claim 12, wherein the first load supporting member includes a flange connected to the set of fasteners.

14. A hydraulic spreader, comprising:
a reservoir wall defining a reservoir chamber configured to contain hydraulic fluid;
a manifold disposed within the reservoir chamber, the manifold including:
an inlet passageway through which the hydraulic fluid in the reservoir chamber enters the manifold;
a plunger passageway in fluid communication with the inlet passageway;
an outlet passageway in fluid communication with the plunger passageway;
a plunger disposed and being movable within the plunger passageway;
a handle pivotally connected to the plunger, movement of the handle relative to the reservoir wall causing the plunger to move in the plunger passageway and thereby draw the hydraulic fluid from the inlet passageway and force the hydraulic fluid to the outlet passageway;
a connection interface connected to the reservoir wall, the connection interface including a delivery passageway in fluid communication with the outlet passageway of the manifold;
a first set of fasteners securing the reservoir wall to the connection interface;
a head assembly connected to the connection interface, the head assembly including:
a lower jaw including a head passageway in fluid communication with the delivery passageway, the lower jaw further including an actuator chamber in fluid communication with the head passageway;
a piston disposed in the actuator chamber, the piston being movable as the hydraulic fluid enters and exits the actuator chamber;
a rod supported by the piston;
an upper jaw pivotally connected to the lower jaw, the upper jaw being movable as the rod and piston move; and
a second set of fasteners securing the lower jaw to the connection interface.

15. The hydraulic spreader of claim 14, wherein the lower jaw includes a flange engaging the second set of fasteners to thereby secure the lower jaw to the connection interface.

16. The hydraulic spreader of claim 14, further comprising an interface capsule disposed between the lower jaw and the connection interface and within the delivery passageway and the head passageway.

17. The hydraulic spreader of claim 14, further comprising at least a first extension spring biasing the upper jaw towards the lower jaw.

18. The hydraulic spreader of claim 14, wherein the connection interface includes:
a first side engaging the reservoir wall;
a second side engaging the head assembly, the second side being opposite the first side.

19. The hydraulic spreader of claim 14, wherein the connection interface further includes a return passageway in fluid communication with the delivery passageway for permitting the hydraulic fluid to return to the reservoir chamber.

20. The hydraulic spreader of claim 19, further comprising a pressure release pin disposed in at least a portion of the return passageway, the pressure release pin being movable for permitting the hydraulic fluid to return to the reservoir chamber.
